(19) United States
(12) Patent Application Publication
(10) Pub. No.: US 2023/0213897 A1
(43) Pub. Date: Jul. 6, 2023

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Ruigang ZHANG, Yokohama (JP); Akira HOSOKAWA, Ichikawa (JP); Shinichi NAGANO, Yokohama (JP)

(73) Assignee: KABUSHIKI KAISHA TOSHIBA, Tokyo (JP)

(21) Appl. No.: 17/822,570

(22) Filed: Aug. 26, 2022

(30) Foreign Application Priority Data
Jan. 4, 2022 (JP) 2022-000157

(51) Int. Cl. G05B 13/04; G06F 16/901; G05B 13/02

(52) U.S. Cl. CPC G05B 13/041; G06F 16/9024; G05B 13/0265

(57) ABSTRACT

According to an embodiment, an information processing device includes one or more processors configured to: extract a first subgraph indicating a connection relation of a first node that matches with a schema in which a connection relation between nodes is defined, among first nodes included in a first graph indicating a connection relation of the first nodes each associated with an attribute; determine a template that is output by a first model by inputting input information based on the first subgraph to the first model, the first model being learned to input the input information based on a subgraph indicating a connection relation between the nodes and to output the template of a formula; and set one of the attributes associated with the first nodes as the variable to be used in the determined template to generate the formula.

### CROSS-REFERENCE TO RELATED APPLICATIONS

This application is based upon and claims the benefit of priority from Japanese Patent Application No. 2022-000157, filed on Jan. 4, 2022; the entire contents of which are incorporated herein by reference.

### FIELD

Embodiments described herein relate generally to an information processing device, an information processing method, and a computer program product.

### BACKGROUND

Technologies for monitoring the operating state and managing the performance of industrial systems have been developed. Formulas for calculating the performance need to be customized and defined for each industrial system. For example, users (such as engineers) who develop the functions of performance management refer to diagrams illustrating the structure of the industrial system (such as a layout diagram, system diagram, equipment diagram, instrument wiring diagram, electrical wiring diagram, foundation diagram, and building diagram), and select one of the attributes of a plurality of assets (such as a hardware device) that are components of the industrial system as a variable in the formula.

However, in the conventional technology, the user needs to manually execute the operation of generating a formula, and the generation operation of formulas may not be executed efficiently.

### BRIEF DESCRIPTION OF THE DRAWINGS

FIG. 1 is a block diagram of an information processing device according to an embodiment;

FIG. 2 is a diagram illustrating an example of a data structure of drawing data indicating a connection relation between assets;

FIG. 3 is a diagram illustrating an example of a data structure of a node list;

FIG. 4 is a diagram illustrating an example of a data structure of an adjacency matrix;

FIG. 5 is a diagram illustrating an example of a data structure of template data;

FIG. 6 is a diagram illustrating an example of a display screen displaying a formula;

FIG. 7 is a diagram illustrating an example of a graph;

FIG. 8 is a diagram illustrating an example of a schema;

FIG. 9 is a diagram illustrating an example of a subgraph to be extracted;

FIG. 10 is a diagram illustrating an example of a subgraph to be extracted;

FIG. 11 is a diagram illustrating an example of a subgraph to be extracted;

FIG. 12 is a diagram illustrating an example of a structure of a model used for predicting a template;

FIG. 13 is a flowchart of a learning process in the present embodiment;

FIG. 14 is a flowchart of an inference process in the present embodiment;

FIG. 15 is a diagram for explaining an example of selecting one of a plurality of asset candidates;

FIG. 16 is a diagram illustrating an example of a structure of a model used in a first modification; and

FIG. 17 is a hardware configuration diagram of the information processing device according to the embodiment.

### DETAILED DESCRIPTION

According to an embodiment, an information processing device includes one or more processors. The one or more processors are configured to: extract a first subgraph indicating a connection relation of a first node that matches with a schema in which a connection relation between a plurality of nodes is defined, among a plurality of first nodes included in a first graph indicating a connection relation of the plurality of first nodes each associated with an attribute; determine a template that is output by a first model by inputting input information based on the first subgraph to the first model, the first model being learned to input the input information based on a subgraph indicating a connection relation between the plurality of nodes and to output the template of a formula in which attributes of one or more nodes included in the subgraph corresponding to the input information are used as variables; and set one of the attributes associated with the plurality of first nodes as the variable to be used in the determined template to generate the formula.

Hereinafter, a preferred embodiment of an information processing device according to the invention will be described in detail with reference to the accompanying drawings.

In the following, an example of an information processing device that generates a formula used for managing performance in industrial systems and the like will be described. However, the system to which the embodiment is applicable is not limited to the industrial system. The industrial system is made of a plurality of components such as a plurality of types of sensors and electronic devices. In the following, the components of an industrial system are referred to as assets. Each of the assets has at least one attribute that can be used as a variable in a formula. For example, to monitor the power of a motor (an example of an asset), the following attributes of the assets may be used as variables in the formula for calculating power.

Asset: a sensor that detects a current of a motor, Attribute: a detected current value (input value of the formula)

Asset: a sensor that detects a voltage of a motor, Attribute: a detected voltage value (input value of the formula)

Asset: a motor, Attribute: a power value (output value of the formula)

The sensor is not limited to a sensor that detects a current or a voltage, but may also be a sensor that detects any physical quantity such as temperature. Moreover, the attributes are not limited to the above, and may be any information. For example, the attributes may also include the type (class) of asset, the manufacturer of asset, and the unit of physical quantity.

To generate a formula used for managing the performance of an industrial system and the like, there is also a method of using a formula template prepared in advance. However, even if a template is used, an operation for selecting an appropriate template, and an operation for specifying the variable to be used in calculation for the selected template are required.

In the example of monitoring the power of a motor, the user needs to select an appropriate template according to another asset nearby that is connected to the motor, and specify one of the attributes of the asset for the variable in the template. The specification of any one of the attributes of the actual asset for the variable in the template is also referred to as the instantiation of the variable in the formula in a template.

The information processing device of the present embodiment learns a model that determines a formula template, using drawing data including formulas generated in the past. The information processing device of the present embodiment then determines the template applied to new drawing data using the learned model, and instantiates the variable in the template. Consequently, the generation operation of formulas can be executed more efficiently.

For example, the information processing device of the present embodiment includes the following functions.

From a diagram illustrating the structure of the industrial system, generate a graph indicating a connection relation between the assets and a formula applied to the asset.

By using a schema in which the connection relation between the assets is determined in advance, extract a subgraph from the generated graph.

Learn a model (an example of a first model) that predicts a template by inputting a subgraph.

Predict a template for the asset included in new drawing data, by the learned model.

Verify the consistency of the predicted template, and if the predicted template is found to be inconsistent, output another template as a prediction result.

Instantiate the variable in the predicted template.

Display the generated formula on a display device so that the formula can be checked and corrected.

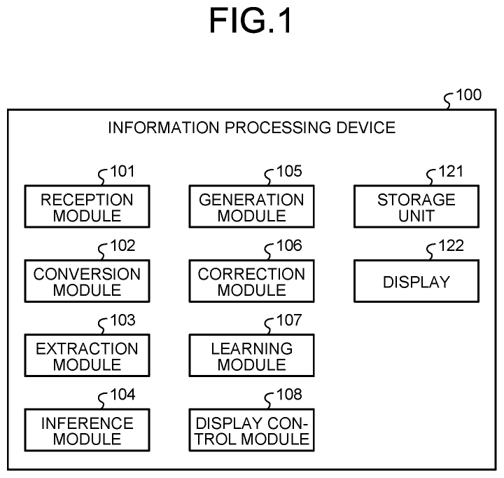

FIG. 1 is a block diagram illustrating an example of a structure of an information processing device 100 according to the present embodiment. As illustrated in FIG. 1, the information processing device 100 includes a reception module 101, a conversion module 102, an extraction module 103, an inference module 104, a generation module 105, a correction module 106, a learning module 107, a display control module 108, a storage unit 121, and a display 122.

The display 122 is a display device for displaying information used in various processes performed by the information processing device 100. For example, the display 122 is implemented by a liquid crystal display, a touch panel having a display function, and the like.

The storage unit 121 stores various types of data used in various processes performed by the information processing device 100. For example, the storage unit 121 stores past drawing data to be used for learning, and data (such as parameters) on the learned model. The storage unit 121 may include any commonly used storage media such as a flash memory, a memory card, a Random Access Memory (RAM), a Hard Disk Drive (HDD), and an optical disc.

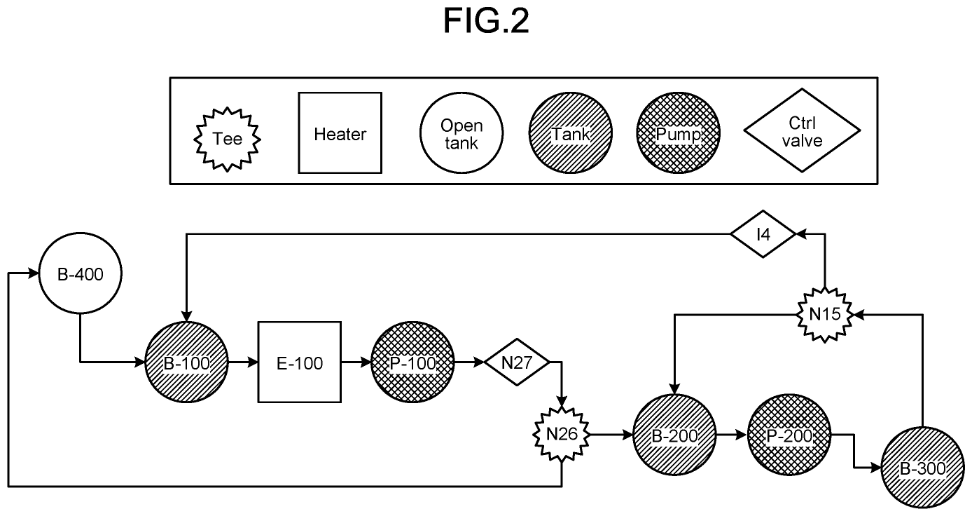

Examples of various types of data stored in the storage unit 121 will be described with reference to FIG. 2 to FIG. 5. FIG. 2 is a diagram illustrating an example of a data structure of drawing data indicating a connection relation between assets. The drawing data in FIG. 2 is an example of data represented by a graph indicating a connection relation between a plurality of assets that are components of an industrial system.

As illustrated in FIG. 2, the drawing data indicates a connection relation between the assets, by associating a plurality of nodes corresponding to the assets with arrows. FIG. 2 illustrates an example of a graph of an industrial system that includes asset types of a T-pipe (Tee), a heater (Heater), an open tank (Opentank), a tank (Tank), a pump (Pump), a control valve (Ctrlvalve), and the like. A symbol “B-400” or the like in each node represents the identification information of the corresponding asset.

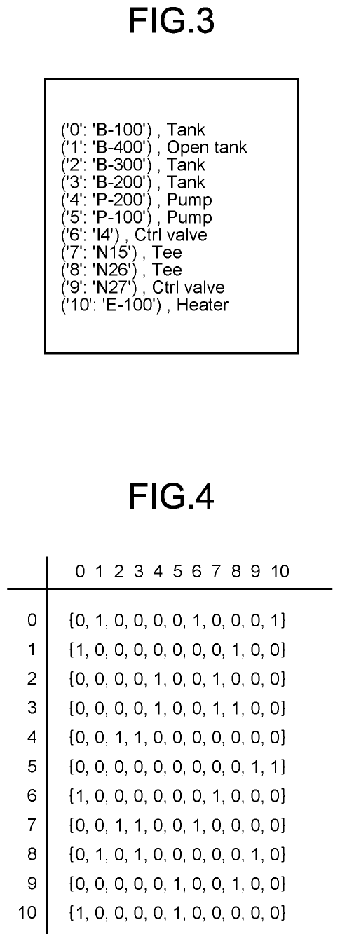

FIG. 3 is a diagram illustrating an example of a data structure of a node list. As illustrated in FIG. 3, the node list includes identification information of assets and the type of assets. In the example in FIG. 3, numerical values from 0 to 10 are associated with each identification information. The numerical values correspond to the rows and columns of the adjacency matrix, which will be described in FIG. 4.

FIG. 4 is a diagram illustrating an example of a data structure of an adjacency matrix. FIG. 4 is an example of the adjacency matrix corresponding to the examples of assets illustrated in FIG. 2 and FIG. 3. The adjacency matrix is information that represents the connection relation between the nodes included in a graph such as FIG. 2 in a matrix form. As described in FIG. 3, the numerical values 0 to 10 in the rows and columns correspond to one of the nodes (assets) in the graph. In each element of the matrix, a value indicating whether a connection is made between the corresponding node in the row and the node in the column is set. In the example in FIG. 4, “1” is set when the connection is made, and “0” is set when the connection is not made.

FIG. 2 to FIG. 4 illustrate examples of the graph that only includes the node corresponding to the asset (asset node), the node list, and the corresponding adjacency matrix. As will be described below, the node may also include the node corresponding to the attribute (attribute node).

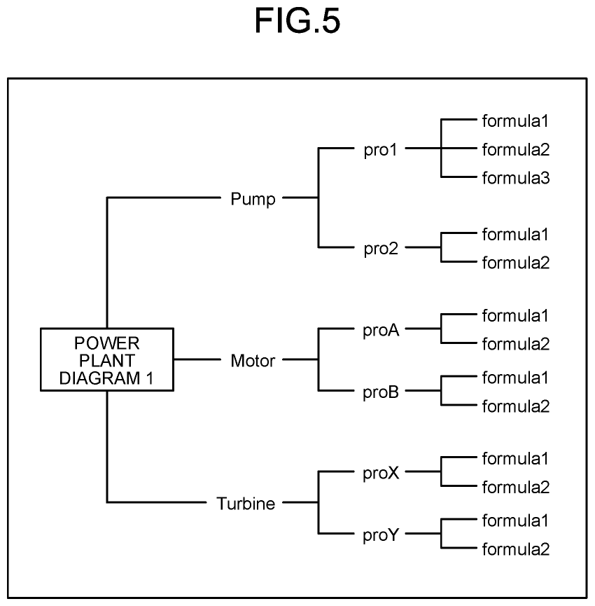

FIG. 5 is a diagram illustrating an example of a data structure of template data indicating templates adopted for assets. As illustrated in FIG. 5, the template data has a data structure in which the asset included in the industrial system and the template adopted for the formula with respect to one or more attributes of the asset are represented in a hierarchical manner. For example, for the pump, three templates of “formula1”, “formula2” and “formula3” are adopted for an attribute “pro1”, and two templates of “formula1” and “formula2” are adopted for an attribute “pro2”.

In this manner, different templates may be applied to the same type of assets. Therefore, it is necessary to select an appropriate template for the same type of assets, from a plurality of candidate templates. The model used in the present embodiment learns to select an appropriate template, by taking into account not only the information on the asset for which a formula is to be generated, but also the connection relation between the asset and another asset nearby.

For example, the data illustrated in FIG. 2 to FIG. 5 are created by the information processing device 100 (conversion module 102) from the drawing illustrating the structure of the industrial system created by an external system. The data illustrated in FIG. 2 to FIG. 5 may also be created by an external system, and input into the information processing device 100.

The reception module 101 receives an input of various types of data used in the information processing device 100. For example, the reception module 101 receives an input of a drawing illustrating the structure of the industrial system from an external system. The input drawing may include the following two types of drawing data.

Drawing data for which a formula is generated and that is not associated with a formula (hereinafter, may also be referred to as drawing data DA).

Drawing data used for learning a model and that is associated with a determined formula (hereinafter, may also be referred to as drawing data DB).

For example, the conversion module 102 converts the drawing illustrating the structure of the industrial system input from an external system and the like in the form of data as illustrated in FIG. 2 to FIG. 5. For example, the drawing illustrating the structure of the industrial system is a Piping & Instrumentation Diagram (P & ID). However, any method may be used to create the drawing. For example, the conversion module 102 creates data as illustrated in FIG. 2 to FIG. 5, by inputting drawing data represented in a format such as Extensible Markup Language (XML) and JavaScript (registered trademark) Object Notation (json) from an external system, and by converting the input drawing data.

For example, the graph indicating the connection relation between the assets illustrated in FIG. 2 may be created for each of the drawing data DA and the drawing data DB. In the following, a graph converted from the drawing data DA may be referred to as a graph GA (an example of a first graph), and a graph converted from the drawing data DB may be referred to as a graph GB (an example of a second graph).

The extraction module 103 extracts a subgraph from the graph as illustrated in FIG. 2. For example, the subgraph is a graph indicating the connection relation of the asset node (an example of a first node) that matches with a predetermined schema, among the nodes included in the entire graph as illustrated in FIG. 2. The subgraph may also include the attribute node corresponding to the attribute of the asset node that matches with the schema. For example, after determining the asset node that matches with the schema, the extraction module 103 may extract a subgraph that includes the determined asset node and the attribute node indicating the attribute of the determined asset node. The schema is information that defines the connection relation between the nodes. Details of the schema and an extraction method of a subgraph using the schema will be described below.

In the following, the subgraph extracted from the graph GA is referred to as a subgraph SA (an example of a first subgraph), and the graph extracted from the graph GB is referred to as a subgraph SB (an example of a second subgraph).

The conversion module 102 may also generate a graph as illustrated in FIG. 2 by converting the input drawing data to match with a schema in the same form as that of the schema used for extraction by the extraction module 103.

By using the learned model, the inference module 104 predicts (infers) a template to be applied to the drawing data DA for which a formula is generated. For example, the model learns to input information based on a subgraph indicating a connection relation between the nodes, and to output a template of a formula in which attributes of one or more nodes included in the subgraph corresponding to the input information are used as variables. The inference means to make a prediction for new input (input information) using a learned model.

For example, the inference module 104 generates input information to be input to the model, from the subgraph (subgraph SA) extracted by the extraction module 103. For example, the input information includes the feature value of the node included in the subgraph, and an adjacency matrix that represents the connection relation of the node included in the subgraph. The feature value of the node includes the type of the node, and the type of another node connected to the node. The inference module 104 inputs the generated input information to the learned model, and determines the template to be output by the model.

The generation module 105 generates a formula by instantiating the variables used in the determined template. The generation module 105 sets one of the attributes associated with a plurality of the asset nodes in the graph GA, as a variable to be used in the determined template.

The variable in the formula (template) may include a variable in which the attribute of the asset is used as an input value of the formula, and a variable in which the attribute is used as an output value of the formula. Therefore, the generation module 105 sets one of the attributes associated with the asset nodes as an input value, and sets one of the attributes that is different from the attribute set as the input value as an output value.

For example, a template includes the type and attributes of the asset that can be set as variables to be used as an input value or output value. From the assets included in the subgraph, the generation module 105 selects the asset that matches with the type included in the template, and sets the attribute included in the template among the attributes of the selected asset, as a variable to be used in the determined template.

The display control module 108 controls the display of information on the display 122. For example, the display control module 108 controls the process of displaying the predicted template and the generated formula on the display 122. The display control module 108 may also display the template or formula on the display 122 so that the template or formula can be checked and corrected. Consequently, the user can check whether the predicted template and the generated formula are appropriate, and correct the template or formula as necessary.

For example, the correction module 106 corrects the model on the basis of a correction instruction from a user with respect to the displayed formula or template.

The learning module 107 learns the model used for predicting the template. For example, the learning module 107 learns the model using learning data obtained from the drawing data DB. For example, the learning data includes the following information.

Input information based on the subgraph SB extracted from the graph GB converted from the drawing data DB

Template associated with the asset node (an example of a second node) included in the graph GB

The learning module 107 can use the template information as correct data during learning. For example, the template information is represented in the form of <instantiated attribute, used template>. Hereinafter, an example of the template information will be described. A plurality of the templates may also be specified as correct data with respect to a single attribute. Moreover, information in which the subgraph and the template (a single template or a template list including the templates) are associated with each other may be used as correct data.

<X1.proA,X_proA_formula1>
<X2.proA,X_proA_formula2>
<W1.proZ,W_proZ_formula1>

For example, each of the units described above (reception module 101, conversion module 102, extraction module 103, inference module 104, generation module 105, correction module 106, learning module 107, and display control module 108) is implemented by one or more hardware processors. For example, each of the units described above may also be implemented by causing a processor such as a Central Processing Unit (CPU) to execute a computer program, that is, by software. Each of the units described above may also be implemented by a processor such as a dedicated Integrated Circuit (IC), that is, by hardware. Each of the units described above may also be implemented by a combination of software and hardware. In the case of using a plurality of processors, each of the processors may implement one of the units or two or more of the units.

Moreover, some or all of the units described above may be integrated into a single component. For example, the generation module 105 may include functions of the extraction module 103 and the inference module 104.

Hereinafter, the details of the process performed by each unit in the information processing device 100 will be further described.

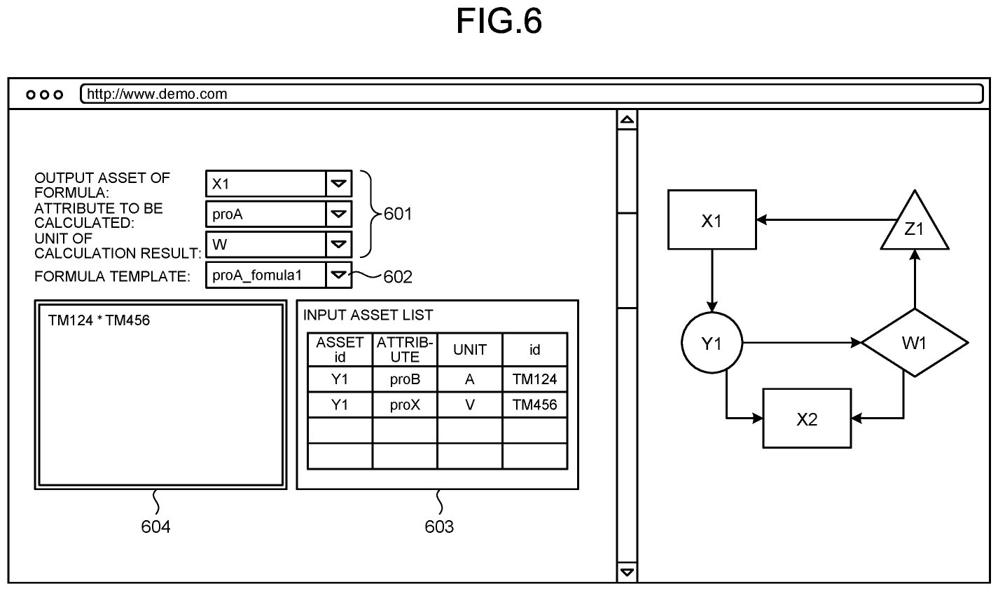

FIG. 6 is a diagram illustrating an example of a display screen displaying a template, formula, and the like. For example, the display screen is displayed on the display 122 by the display control module 108. In FIG. 6, a formula is generated for the asset X1 included in the graph displayed on the right hand side. The graph indicates the connection relation of five assets W1, X1, X2, Y1, and Z1. X1 and X2 are assets of the same type (X).

A field 601 is a field for setting a variable to be the output value of a formula. For example, in the field 601, the identification information of an asset with which the output value of the formula is associated, the attribute for which the output value is calculated by the formula, and the unit of the calculation result are set. A field 602 is a field for setting a formula template.

A field 603 is a field for setting a variable to be the input value of the formula. For example, in the field 603, the identification information (asset id) of the asset having an attribute used as an input value, the attribute, the unit, and the identification information (id) of the instantiated variable are set. The field 604 is a field for displaying a formula in which the variables are instantiated.

For example, in the conventional technology, when the display screen as illustrated in FIG. 6 is used, the user had to specify the template to be applied, the attribute to be used as an input value, and the like. In contrast, in the present embodiment, such information can be predicted using the pre-learned model, without user specification. The predicted information is displayed on the display screen as illustrated in FIG. 6 so that the user can check and correct the information.

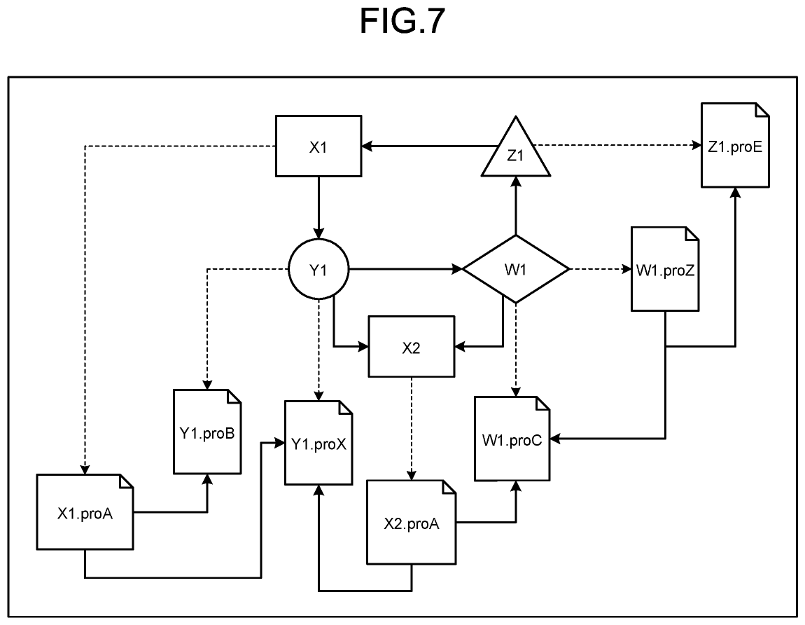

FIG. 7 is a diagram illustrating an example of the graph GA. The graph GA in FIG. 7 illustrates the connection relation of the five assets W1, X1, X2, Y1, and Z1. One or more attributes are associated with each of the assets. For example, two attributes of W1.proC and W1.proZ are associated with the asset W1.

The attribute value (output value) of a certain asset may be calculated from the attribute value (input value) of one or more other assets. In FIG. 7, a plurality of arrows from one attribute to the other attribute illustrate such a correspondence between the input value and the output value. For example, the value of the attribute X1.proA of the asset X1 is calculated using the attribute Y1.proB and the attribute Y1.proX of the asset Y1 as input values. The information processing device 100 of the present embodiment generates a formula, by predicting a formula template used for such a calculation, and determining attributes to be the input value and output value.

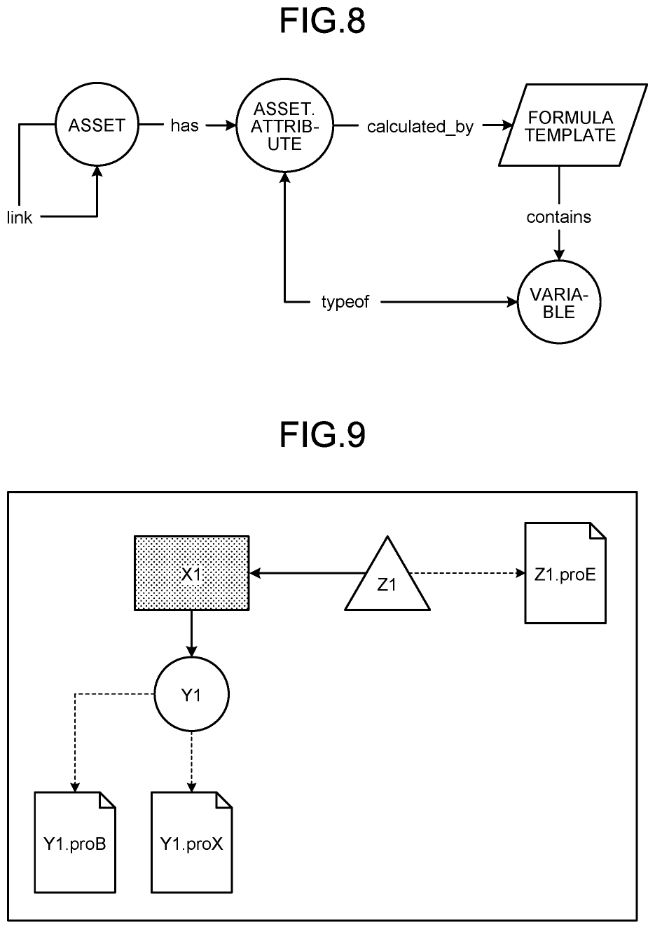

FIG. 8 is a diagram illustrating an example of a schema. As illustrated in FIG. 8, the schema includes the nodes, and edges that indicate the relation of a plurality of types of nodes or the relation of the same type of nodes. For example, the types of nodes include the asset, attribute, variable, and formula template. In this manner, the type of node in the schema is different from the type of asset included in the graph described above and the like. For example, the edges indicate the following relations.

link: A relation in which the source node of an edge is connected to the destination node of the edge has: A relation in which the source node of an edge owns the destination node of the edge calculated by: A relation in which the source node of an edge is calculated using the destination node of the edge contains: A relation in which the source node of an edge includes the destination node of the edge type of: A relation in which the source node of an edge indicates the type of the destination node of the edge

Hereinafter, examples (E1) to (E5) of the definition of the edge will be described.

(E1)<asset, link, asset>.
(E2)<asset, has, asset.attribute>
(E3)<asset.attribute, calculated by, template>
(E4)<template, contains, variable>.
(E5)<variable, type of, asset.attribute>

Hereinafter, specific examples of data (D1) to (D5) that fall under (E1) to (E5) will be described.

(D1)<X1, link, Y1>
(D2)<X1, has, X1.proA>
(D3)<W1.proZ, calculated by, W_proZ_formula1>
(D4)<W_proZ_formula1, contains, Z1.proE>
(D5)<X1.proA, type of, X.proA>

(E1) indicates a relation in which the assets are connected with each other. Therefore, this relation can also be satisfied when three or more assets are continuously connected with each other in addition to only two assets. On the other hand, the output value of the attribute of a certain asset is often calculated using the value of the attribute of another asset nearby, as an input value. Thus, it may be preferable to limit the other asset to be extracted to the asset nearby. Therefore, the extraction module 103 may set the upper limit to the number of continuous assets (hereinafter, may be referred to as a hop count) to extract the subgraph that matches with the connection relation of the assets within the upper limit of the hop count. The upper limit of the hop count may be adjusted as a parameter.

Moreover, the graph GA converted from the drawing data DA that is not associated with a formula may not include a template. Thus, for the graph GA, the extraction module 103 may extract the subgraph SA that matches with the schema that does not include a template and a variable.

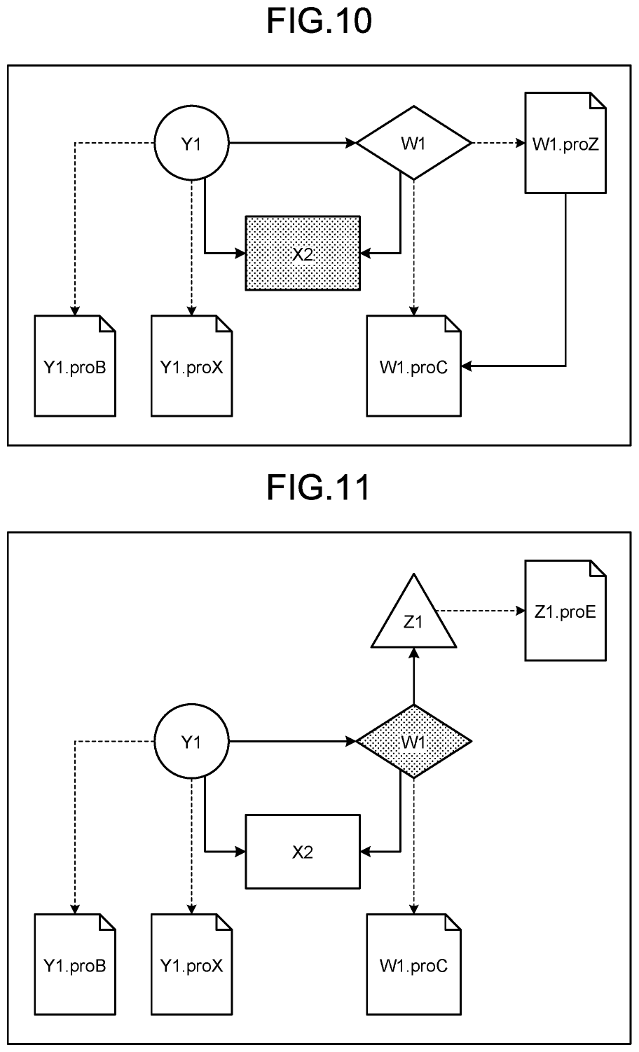

FIG. 9 to FIG. 11 are each a diagram illustrating an example of a subgraph to be extracted. Each of FIG. 9 to FIG. 11 is an example of the subgraph SA extracted from the graph GA illustrated in FIG. 7, as a graph that matches with the schema illustrated in FIG. 8. For example, FIG. 9 illustrates the subgraph SA including the assets Y1 and Z1 that are up to one hop (upper limit of the hop count=1) from the asset X1, and the attributes of the assets. FIG. 10 illustrates the subgraph SA including the assets Y1 and W1 that are up to one hop from the asset X2, and the attributes of the assets. FIG. 11 illustrates the subgraph SA including the assets X2, Y1, and Z1 that are up to one hop from the asset W1, and the attributes of the assets.

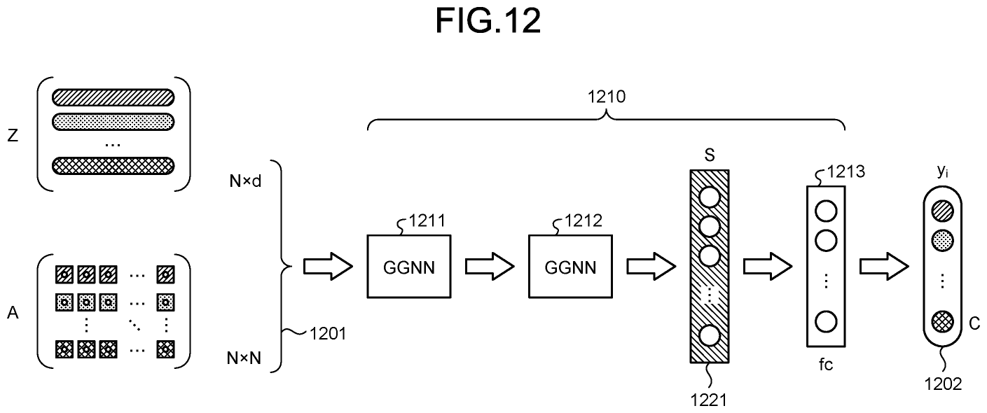

FIG. 12 is a diagram illustrating an example of a structure of a model 1210 used for predicting a template. The model 1210 inputs input information 1201 and outputs a vector 1202 corresponding to the prediction result. The model 1210 includes two Gated Graph Neural Networks (GGNNs) 1211 and 1212 and a function 1213. A vector 1221 is data output by the GGNN 1212, and is a vector S representing the feature value of the subgraph.

The input information 1201 includes a feature value Z of the node included in the subgraph and an adjacency matrix A of the subgraph. N indicates the number of nodes in the subgraph, and d indicates the number of dimensions of the feature value of each node. Each row of the feature value Z corresponds to the feature value of a certain node.

For example, the feature value of the node is created by the following procedure.

(M1) When the node is the asset node: the following three types of vectors are connected.

V1: One-hot vector indicating the type of asset node (if the number of types of assets is M, an M-dimensional vector)

V2: One-hot vector indicating the manufacturer (if the number of manufacturers is L, an L-dimensional vector)

V3: For each type of asset, the number of corresponding asset node within k hops (k is an integer greater than or equal to 1) from the asset node (an M-dimensional vector)

The number of dimensions d can be determined as follows.

Number of dimensions d=Number of types of assets M+Number of manufacturers L+Number of types of assets M

(M2) when the node is the attribute node:

The feature value of the attribute node is calculated by setting three sets of <asset.attribute, usedin, template of asset.attribute> as input data, and using the model learned to output the output data of the number of dimension d as a feature value. For example, the model can be implemented by TransE as developed in Antoine Bordes et al., “Translating Embeddings for Modeling Multi-relational Data”, Advances in Neural Information Processing Systems 26 (NIPS 2013).

For example, the vector 1202 is a one-hot vector y₁ that includes C pieces (C is the total number of templates) of elements corresponding to all templates, in which only the element corresponding to the predicted template is “1” and the other element is “0”. Note that i is an index of the input information 1201. For example, during learning, a plurality of pieces of the input information 1201 corresponding to a plurality of the indexes i are used as learning data.

For example, the model 1210 may calculate a score for each template, and set the element corresponding to the template that maximizes the calculated score to “1”, and set the element corresponding to the other templates to “0”. The score represents information indicating that the value is increased with an increase in the probability of the template for the input subgraph. The vector 1202 may not be in the form of one-hot vector, and may be a vector the element of which is the score for each template.

The GGNNs 1211 and 1212 are graph neural networks that take the type and direction of the edge into account. For example, the function 1213 is a MultiLayer Perceptron (MLP) function fc. The number of dimensions of the output of the function fc is the same as the total number C of the templates.

During inference, the inference module 104 inputs the input information 1201 generated from the subgraph SA to the model 1210, and determines the template as a prediction result from the vector 1202 output by the model 1210.

During learning, the learning module 107 inputs the input information 1201 generated from the subgraph SB to the model 1210, and determines the vector 1202 output by the model 1210. The learning module 107 then learns the model 1210 using a loss function based on the determined vector 1202 and the vector lᵢ of the template corresponding to the correct data. The learning method may be any method, but a method of determining a parameter of the model 1210 that minimizes the loss function may be applicable. For example, the loss function is represented by the following equation (1).

$$\begin{matrix}L ( {y}_{i} , {l}_{i} ) = - \frac{1}{C} {\sum }_{j = 1}^{C} {l}_{i j} log ( {( 1 + exp ( - {y}_{i j} ) )}^{- 1} ) \\ + ( 1 - {l}_{i j} ) log ( \frac{exp ( - {y}_{i j} )}{( 1 + exp ( - {y}_{i j} ) )} )\end{matrix} \qquad ( 1 )$$

As described in FIG. 5, different templates may be applied to the same type of assets. For example, it is assumed that X1 and X2 in FIG. 7 correspond to the motor (Motor) in FIG. 5, and that the template of formula1 is used for the attribute proA of X1 and the template of formula2 is used for the attribute proA of X2. In the present embodiment, even in such a case, it is possible to predict an appropriate template between the two templates (formula1, formula2) applicable to X.proA, by not only taking into account the feature values (V1, V2) of the asset (node) in question, but also the feature value (V3) of another asset (node) nearby.

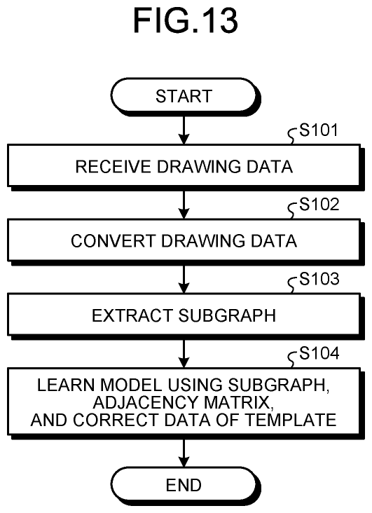

Next, a learning process performed by the information processing device 100 according to the present embodiment will be described. The learning process is a process of learning a model performed by the learning module 107. FIG. 13 is a flowchart illustrating an example of a learning process in the present embodiment.

For example, the reception module 101 receives an input of the drawing data DB associated with a formula, from an external system (step S101). The conversion module 102 converts the drawing data DB (step S102). For example, the conversion module 102 converts the drawing data DB into the graph GB as illustrated in FIG. 2, the node list as illustrated in FIG. 3, the adjacency matrix as illustrated in FIG. 4, and the template data as illustrated in FIG. 5. The extraction module 103 extracts the subgraph SB from the graph GB (step S103). The learning module 107 learns the model using the subgraph SB, the adjacency matrix, the correct data of the template, and the like (step S104).

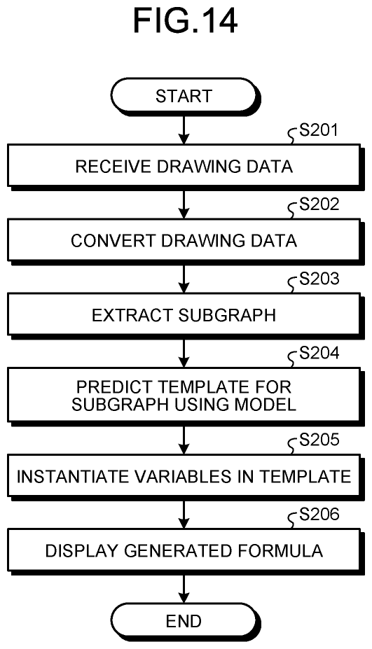

Next, an inference process performed by the information processing device 100 according to the present embodiment will be described. The inference process is a process of predicting the template using the learned model performed by the inference module 104. FIG. 14 is a flowchart illustrating an example of the inference process in the present embodiment.

Steps S201 to S203 are the same as steps S101 to S103 in FIG. 13, except that the drawing data DA is used instead of the drawing data DB.

That is, for example, the reception module 101 receives an input of the drawing data DA that is not associated with a formula, from an external system (step S201). The conversion module 102 converts the drawing data DA (step S202). For example, the conversion module 102 converts the drawing data DA into the graph GA as illustrated in FIG. 2, the node list as illustrated in FIG. 3, the adjacency matrix as illustrated in FIG. 4, and the template data as illustrated in FIG. 5. The extraction module 103 extracts the subgraph SA from the graph GA (step S203).

The inference module 104 predicts the template for the subgraph SA using the learned model (step S204). For example, the inference module 104 first generates input information as illustrated in FIG. 12, from the subgraph SA. The inference module 104 inputs the generated input information to the model, and determines the template for the subgraph SA from the output of the model.

The generation module 105 generates a formula, by instantiating the variables used in the determined template (step S205). For example, the display control module 108 displays the generated formula on the display screen as illustrated in FIG. 6 (step S206). As described above, the display control module 108 may display a display screen capable of checking and correcting the formula on the display 122.

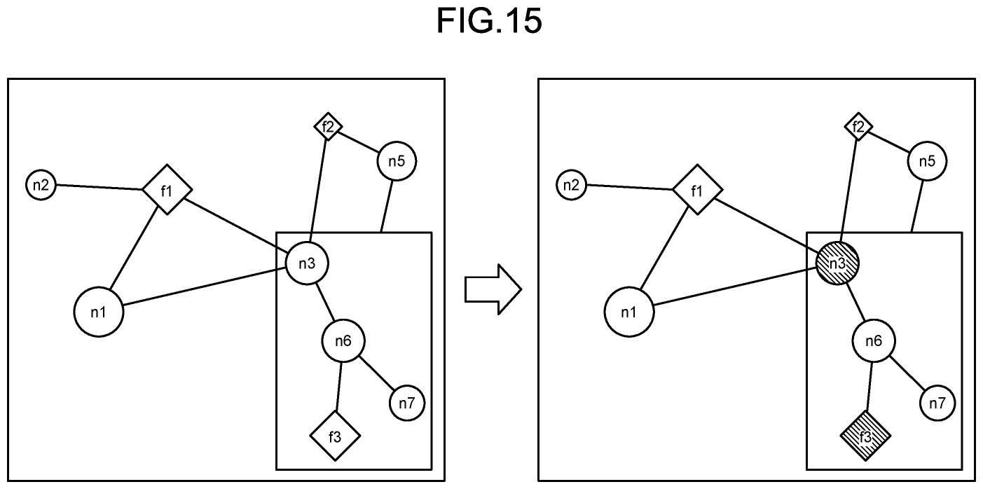

A subgraph may include a plurality of types of assets that can be set as variables in the template. In such a case, the generation module 105 selects one of the assets and sets the selected asset as a variable in the template. FIG. 15 is a diagram for explaining an example of selecting one of a plurality of asset candidates.

FIG. 15 illustrates an example when a subgraph including nodes n3, n7, and f3 that are one hop from the node n6 is extracted from a graph including nodes n1 to n7 the type of which is “n”, and nodes f1 to f3 the type of which is “f”. For example, for the subgraph, it is assumed that a template capable of setting the attribute of the asset of the type n and the attribute of the asset of the type f as variables is predicted. In this example, two nodes of n3 and n7 are included in the subgraph as the nodes corresponding to the asset of the type n. In such cases, the generation module 105 needs to select one of n3 and n7 to instantiate as a variable in the template.

For example, the generation module 105 may use the display control module 108 to display a display screen for selecting an asset, and select the asset specified by the user using the display screen. The generation module 105 may also select an asset using a model learned to select an appropriate asset from the asset candidates. Such a model may be integrated with the model for predicting the template described above.

Next, a correction process of the model performed by the correction module 106 will be described. The display control module 108 may display a screen for adding a new template on the display 122. The user can add a new template by using such a screen.

When a new template is added, the model needs to be corrected so that the added template can be output as a prediction result. First, the correction module 106 corrects the model so that the added template can be output as a prediction result. For example, as an element of the vector 1202 corresponding to the prediction result, the correction module 106 adds an element corresponding to the added template. Moreover, the correction module 106 creates learning data that has taken the added template into account. For example, the correction module 106 inputs a set of three including the added template into TransE as input data, and determines the feature value of the attribute node. The correction module 106 corrects the model, by relearning the model using the learning data including the determined feature value.

First Modification

When the hop count is increased, the template can be predicted by taking into account the features of more assets nearby. Hence, it is possible to improve the prediction accuracy. On the other hand, when the hop count is increased, there may be a situation in which the template to be used as correct data (the template to be predicted) cannot be determined for the subgraph to be extracted. For example, a case is considered when the subgraph SB up to two hops from the specified asset is extracted from the graph GB having the same structure as that of the graph GA in FIG. 7. It is assumed that the following three templates are adopted for the assets in the graph GB.

(T1) “formula1” for the attribute proA of the asset X1 (variables are Y.proB, Y.proX)
(T2) “formula2” for the attribute proA of the asset X2 (variables are Y.proX, W.proC)
(T3) “formula1” for the attribute proZ of the asset W1 (variables are Z.proE, W.proC)

In this case, the extracted subgraph SB will be the same (the entire graph GB), no matter which of the assets (W1, X1, X2, Y1, Z1) in the graph GB is specified. For example, the same subgraph SB is extracted for the asset X1 and the asset X2 the type of which is the same asset X. In such a case, it is not possible to determine which of “formula1” and “formula2” should be the correct data, as the template to be predicted when the subgraph SB is input to the model.

Moreover, even if the correct data is determined and learning has taken place, there may be a case when the template predicted by the model cannot be determined to correspond to which of the actual assets. For example, it is assumed that a model is learned using the correct data that can predict templates for a single attribute, and that two templates of X_proA_formula1 and X_proA_formula2 are predicted by the model. In such a case, it may not be possible to determine how the templates X_proA_formula1 and X_proA_formula2 correspond to the two assets X1 and X2 in the subgraph SB. For example, even if the asset X1 should be used for the template X_proA_formula1 and the asset X2 should be used for the template X_proA_formula2, such correspondence may not be specified only from the prediction result.

Therefore, the present modification further uses a model (an example of a second model) that predicts a template using the feature value of each asset as input information. By using the model (for example, the model 1210 in FIG. 12) that predicts the template of the embodiment described above, this model is learned as a model different from the model that predicts the template of the embodiment described above.

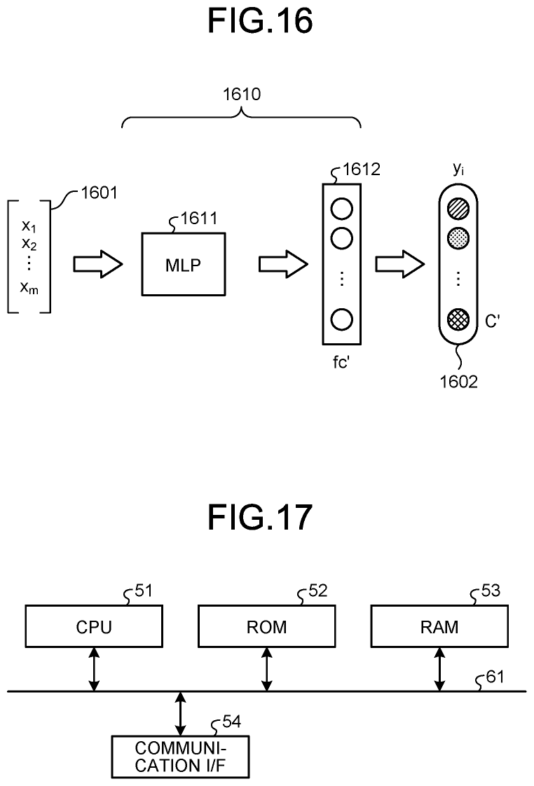

FIG. 16 is a diagram illustrating an example of a structure of a model 1610 used in the present modification. The model 1610 may be learned for each asset, or may be learned as a common model for all assets. The model 1610 inputs input information 1601 and outputs a vector 1602 corresponding to the prediction result. The model 1610 includes an MLP 1611 and a function 1612.

For example, the function 1612 is an MLP function fc′. The number of dimensions of the output of the function fc′ (vector 1602) is the same as the total number C′ of templates that may be predicted for the asset corresponding to the model 1610. The total number C′ may be a different value for each asset. If the model 1610 is learned as a common model for all assets, C′ may be the same value as C that is the number of dimensions of the vector 1202 output by the model in the embodiment described above.

The input information 1601 is an m-dimensional (m is an integer greater than or equal to 2) vector corresponding to the feature value of the asset for which the model is learned. For example, the feature value of the asset may be extracted as information (a vector) corresponding to the asset node that corresponds to the asset, in the output of the GGNN 1211 or GGNN 1212 (an example of intermediate data) in the model 1210.

The learning module 107 learns the model 1610 as follows. By using the learned model 1210, the learning module 107 determines the input information 1601 corresponding to the feature value of the specified asset. The learning module 107 inputs the determined input information 1601 to the model 1610, and determines the vector 1602 output by the model 1610. The learning module 107 then learns the model 1610 using a loss function based on the determined vector 1602 and the vector lᵢ of the template corresponding to the correct data for the specified asset. The learning method may be any method, but a method of determining a parameter of the model 1610 that minimizes the loss function may be applicable. For example, the function similar to the equation (1) described above may be used for the loss function.

The model 1210 and the model 1610 may be interpreted as models used when the hop count 1 and the hop count 2 are specified. Therefore, the inference module 104 predicts the template to be applied to the drawing data DA, using one of the model 1210 and model 1610 as follows, according to the specified hop count.

If the hop count 1 is specified, the inference module 104 predicts the template using the model 1210 according to the procedure in the embodiment described above. If the hop count 2 is specified, the inference module 104 first generates the input information 1201 using the same procedure as that in the embodiment described above, and inputs the generated input information 1201 to the model 1210. From the output of the GGNN 1211 or the GGNN 1212 in the model 1210, the inference module 104 extracts the information (vector) corresponding to the asset node that corresponds to the specified asset, as the input information 1601. The inference module 104 inputs the input information 1601 to the model 1610 that is learned as a model corresponding to the specified asset, and determines the template output by the model 1610.

Second Modification

The template predicted by the model may not be appropriate. For example, it is assumed that the template “formula2” predicted for the asset X uses the attribute proX of the asset Y and the attribute proC of the asset W as variables. However, for example, if the asset X is not connected to the asset W, this template cannot be used.

Therefore, in the present modification, for example, the inference module 104 verifies the consistency of the predicted template, and if the predicted template is found to be inconsistent, the inference module 104 further predicts another template and outputs the other template as a prediction result. For example, the inference module 104 verifies the consistency of the template, by referring to a knowledge database obtained from the past drawing data DB and the like. For example, as (T1) to (T3) described above, the knowledge database includes the template adopted for each asset, and the variable used in the template (such as the attribute of adjacent node).

The inference module 104 predicts the template using a model that can calculate the score for each template and output the calculated score as intermediate data or the prediction result. The inference module 104 verifies the consistency of the predicted template. For example, the inference module 104 determines the other asset node used as a variable in the predicted template for the specified asset and the attributes of the asset node, from the knowledge database. The inference module 104 verifies whether the determined asset node is connected to the specified asset, and whether the determined attribute is included in the attributes of the other asset node connected to the specified asset. If the determined asset node is not connected to the specified asset, and if the determined attribute is not included in the attributes of the other asset node connected to the specified asset, the inference module 104 determines that there is an inconsistency.

For example, if it is determined that there is an inconsistency, the inference module 104 determines the template with the next highest score, and repeats the verification of consistency for the determined template. The inference module 104 outputs the template the consistency of which is verified as a prediction result.

When the specification of a template is changed by the user, the verification of consistency can also be used as a function for determining whether the changed template is applicable to the specified asset.

In this manner, the information processing device of the present embodiment can determine a template to be applied to new drawing data using the learned model, and specify a variable to be used for calculation included in the template. Consequently, the generation operation of formulas can be executed more efficiently.

Next, a hardware configuration of the information processing device according to the embodiment will be described with reference to FIG. 17. FIG. 17 is an explanatory diagram illustrating an example of a hardware configuration of the information processing device according to the embodiment.

The information processing device according to the embodiment includes a control device such as a CPU 51, a storage device such as a Read Only Memory (ROM) 52 and a RAM 53, a communication interface (I/F) 54 that performs communication by connecting to a network, and a bus 61 that connects each unit.

The computer program executed by the information processing device according to the embodiment is provided by being incorporated in advance in the ROM 52 or the like.

The computer program executed by the information processing device according to the embodiment may also be recorded on a computer-readable recording medium such as a Compact Disk Read Only Memory (CD-ROM), a flexible disk (FD), a Compact Disk Recordable (CD-R), and a Digital Versatile Disk (DVD) in an installable or executable file format, and provided as a computer program product.

Moreover, the computer program to be executed by the information processing device according to the embodiment may be stored on a computer connected to a network such as the Internet, and provided by being downloaded through the network. Furthermore, the computer program executed by the information processing device according to the embodiment may be provided or distributed via a network such as the Internet.

The computer program executed by the information processing device according to the embodiment can cause a computer to function as the units of the information processing device described above. In the computer, the CPU 51 can read a computer program from a computer-readable storage medium onto the main storage device and execute the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
one or more processors configured to:
extract a first subgraph indicating a connection relation of a first node that matches with a schema in which a connection relation between a plurality of nodes is defined, among a plurality of first nodes included in a first graph indicating a connection relation of the plurality of first nodes each associated with an attribute;
determine a template that is output by a first model by inputting input information based on the first subgraph to the first model, the first model being learned to input the input information based on a subgraph indicating a connection relation between the plurality of nodes and to output the template of a formula in which attributes of one or more nodes included in the subgraph corresponding to the input information are used as variables; and
set one of the attributes associated with the plurality of first nodes as the variable to be used in the determined template to generate the formula.

2. The device according to claim 1, wherein the input information includes a feature value of the first node included in the first subgraph, and an adjacency matrix that represents the connection relation of the first nodes included in the first subgraph in a matrix form.

3. The device according to claim 2, wherein the feature value includes a type of the first node and a type of another node connected to the first node.

4. The device according to claim 1, wherein
the variable includes a variable that uses the attribute as an input value of the formula and a variable that uses the attribute as an output value of the formula, and
the one or more processors are configured to set one of the attributes associated with the plurality of first nodes as the input value, and set one of the attributes different from the attribute set as the input value as the output value.

5. The device according to claim 1, wherein
the one or more processors are configured to:
receive an input of a second graph that indicates a connection relation of a plurality of second nodes each associated with an attribute and in which the template is associated with at least a part of the second nodes, and extract a second subgraph that indicates a connection relation of second nodes that match with the schema, among the plurality of second nodes included in the received second graph; and
learn the first model by using learning data including input information based on the second subgraph and the template associated with the second nodes.

6. The device according to claim 1, wherein the one or more processors are further configured to control a process of displaying the generated formula on a display device.

7. The device according to claim 1, wherein the one or more processors are further configured to correct, when a new template is added, the first model to be able to output the added template.

8. The device according to claim 1, wherein the one or more processors are configured to determine the template that is output by a second model by inputting to the second model input information based on intermediate data output by the first model, the second model being learned to input the input information based on the intermediate data output by the first model and to output the template.

9. The device according to claim 1, wherein the one or more processors are configured to extract the first subgraph indicating a connection relation of the first node that matches with the schema and an attribute node indicating an attribute of the first node that matches with the schema.

10. The device according to claim 1, wherein
the one or more processors are configured to:
extract the first subgraph; and
infer the template by inputting the input information based on the first subgraph to the first model.

11. An information processing method that is executed by an information processing device, the method comprising:
extracting a first subgraph indicating a connection relation of a first node that matches with a schema in which a connection relation between a plurality of nodes is defined, among a plurality of first nodes included in a first graph indicating a connection relation of the plurality of first nodes each associated with an attribute;
determining a template that is output by a first model by inputting input information based on the first subgraph to the first model, the first model being learned to input the input information based on a subgraph indicating a connection relation between the plurality of nodes and to output the template of a formula in which attributes of one or more nodes included in the subgraph corresponding to the input information are used as variables; and
setting one of the attributes associated with the plurality of first nodes as the variable to be used in the determined template to generate the formula.

12. A computer program product comprising a non-transitory computer-readable medium including programmed instructions, the instructions causing a computer to execute:
extracting a first subgraph indicating a connection relation of a first node that matches with a schema in which a connection relation between a plurality of nodes is defined, among a plurality of first nodes included in a first graph indicating a connection relation of the plurality of first nodes each associated with an attribute;
determining a template that is output by a first model by inputting input information based on the first subgraph to the first model, the first model being learned to input the input information based on a subgraph indicating a connection relation between the plurality of nodes and to output the template of a formula in which attributes of one or more nodes included in the subgraph corresponding to the input information are used as variables; and
setting one of the attributes associated with the plurality of first nodes as the variable to be used in the determined template to generate the formula.
